(19) United States
(12) Patent Application Publication
(10) Pub. No.: US 2013/0148197 A1
(43) Pub. Date: Jun. 13, 2013

(54) Apparatus and a Method of Manufacturing an Apparatus

(71) Applicants: Thomas FRANKE, Ulm (DE); Jens Rasmussen, Ulm (DE); Heiko Schiller, Ulm (DE); Gerhard Scheuing, Ulm (DE)

(72) Inventors: Thomas FRANKE, Ulm (DE); Jens Rasmussen, Ulm (DE); Heiko Schiller, Ulm (DE); Gerhard Scheuing, Ulm (DE)

(73) Assignee: Nokia Corporation

(21) Appl. No.: 13/316,818

(22) Filed: Dec. 12, 2011

(51) Int. Cl. G02B 5/30; B05D 5/06; B44C 1/22; B05D 5/12

(52) U.S. Cl. 359/483.01; 427/58; 216/24

(57) ABSTRACT

An apparatus including a component of a circular polarizer; and conductive interconnect integrated with the component of the circular polarizer.

### TECHNOLOGICAL FIELD

Embodiments of the present invention relate to an apparatus and a method of manufacturing an apparatus. In particular, they relate to an apparatus that is suitable for use in a touch window module.

### BACKGROUND

A touch window module is a module that is positioned over a display to create a touch sensitive display.

### BRIEF SUMMARY

According to various, but not necessarily all, embodiments of the invention there is provided an apparatus comprising: a component of a circular polarizer; and conductive interconnect integrated with the component of the circular polarizer.

According to various, but not necessarily all, embodiments of the invention there is provided a method comprising: providing a component of a circular polarizer having an exterior surface; and providing a conductive interconnect on an exterior surface of the component of the circular polarizer.

The apparatus may be used as a component in a touch window module. The apparatus does not require a separate substrate for the conductive interconnects and is consequently thinner and potentially less expensive.

### BRIEF DESCRIPTION

For a better understanding of various examples of embodiments of the present invention reference will now be made by way of example only to the accompanying drawings in which:

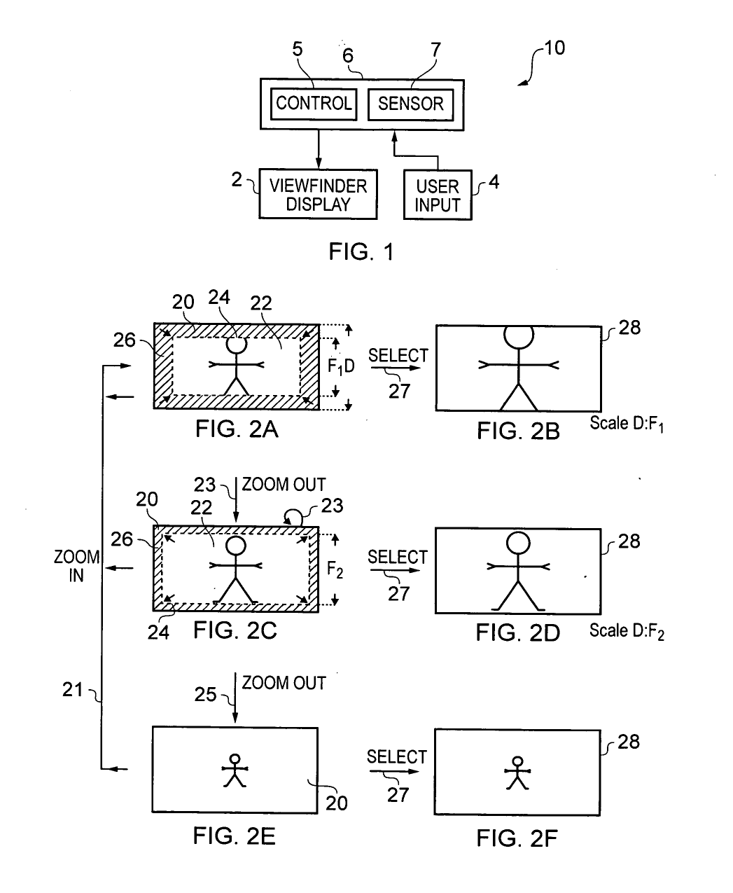

FIG. 1 schematically illustrates an apparatus comprising: a component of a circular polarizer; and conductive interconnect integrated with the component of the circular polarizer;

FIG. 2 schematically illustrates a circular polarizer where the conductive interconnect has been applied directly to an exterior surface of the ¼ wave retarder;

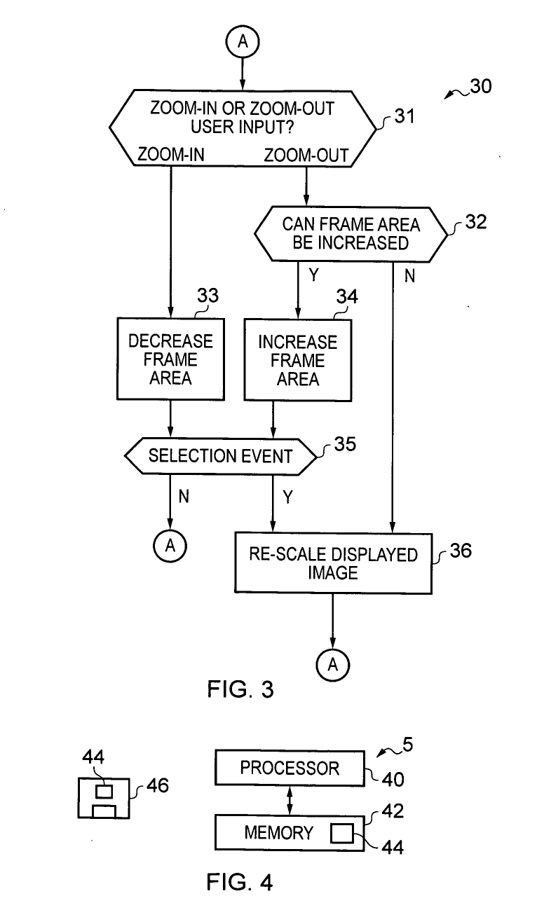

FIG. 3 schematically illustrates a circular polarizer where the conductive interconnect has been applied directly to an exterior surface of the linear polarizer;

FIG. 4 schematically illustrates a device comprising a display module and a touch window module; and

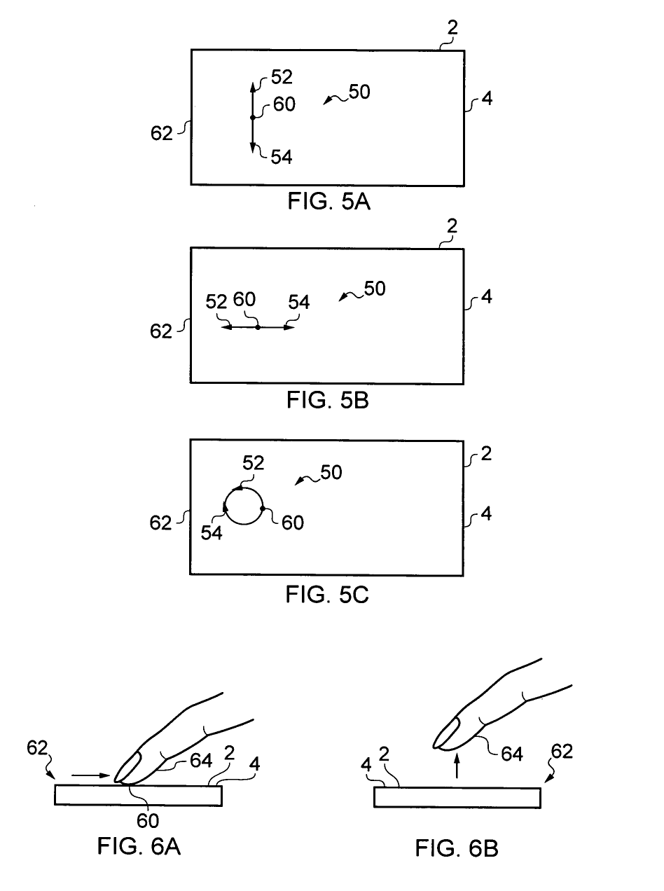

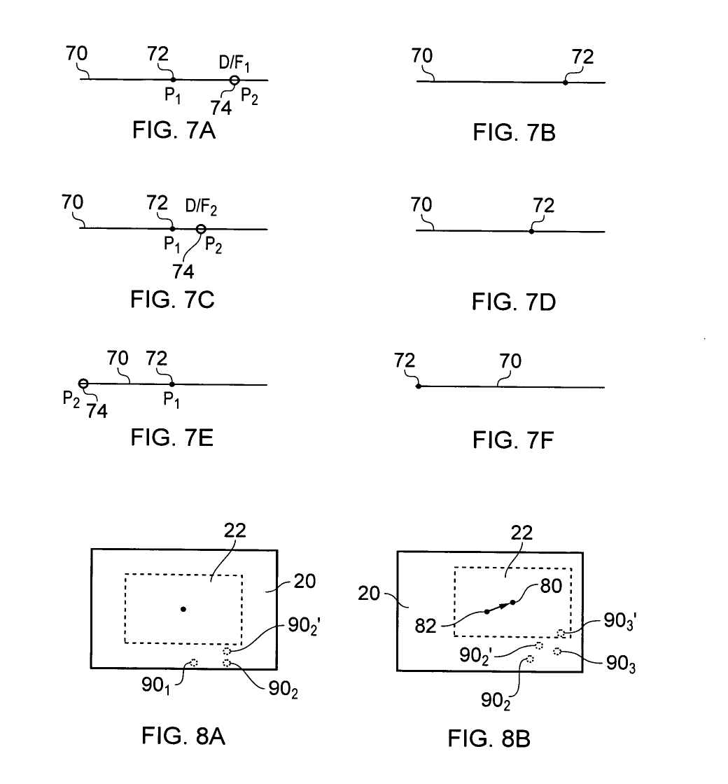

FIG. 5 schematically illustrates a portion or a whole of either a circular polarizer or a component of a circular polarizer comprising a first conductive interconnect and a second conductive interconnect.

### DETAILED DESCRIPTION

The Figures illustrate an apparatus 2 comprising: a component 6 of a circular polarizer 4; and conductive interconnect 10 integrated with the component 6 of the circular polarizer 4.

FIG. 1 schematically illustrates an apparatus 2 comprising: a component 6 of a circular polarizer; and conductive interconnect 10 integrated with the component 6 of the circular polarizer 4.

The conductive interconnect 10 is applied directly to the component 6 of the circular polarizer 4. There is no additional transport substrate used, therefore there is no intervening substrate between the conductive interconnect 10 and the component 6.

A circular polarizer comprises two components that operate in combination are typically physically combined when in use. The components 6 are a ¼ wave retarder 6A and a linear polarizer 6B (FIGS. 2, 3). Reference to a component 6 may be a reference to a ¼ wave retarder 6A, a linear polarizer 6B or a combination of a ¼ wave retarder 6A and a linear polarizer 6B.

The component 6 of the circular polarizer 4 may be formed from a suitable material onto which the conductive interconnect 10 is directly applied. One example of a suitable material is polyethylene terephthalate.

The conductive interconnect 10 may be applied directly to the component 6 using an additive process such as printing or a subtractive process such as blanket deposition followed by photolithography and chemical etching.

The conductive interconnect 10 may be made from any suitable conductive material or materials that is suitably robust.

The conductive interconnect 10 may be ductile. This is advantageous as it provides robustness.

The conductive interconnect 10 may, for example, comprise metal. It may for example be formed from copper or silver.

The material forming the conductive interconnect 10 is not typically transparent. However, the dimensions of the conductive interconnect may be sufficiently small so that the conductive interconnect 10 is not resolvable by a human eye.

In the illustrated example, the conductive interconnect 10 is a mesh. The mesh 10 in this example occupies a single flat plane at the surface 3 of the component 6. Reference to a surface 3 may be a reference to a surface 3A of a ¼ wave retarder 6A or a surface 3B of a linear polarizer 6B.

The mesh 10 comprises a plurality of first conductive lines 12 extending in a first direction D1 and a plurality of second conductive lines 14 extending in a second direction D2, orthogonal to the first direction. The directions D1, D2 lie in plane at the surface 3 of the component.

Some of the first conductive lines 12 and the plurality of second conductive lines 14 interconnect at nodes 16. In some embodiments the mesh may form an intact grid where each of the first conductive lines 12 connects to a second conductive line 14 via a node 16 and each of the second conductive lines 14 connects to a first conductive line 12 via a node 16. However, in other embodiments the grid may not be intact (either intentionally or unintentionally) and there may be gaps in the first conductive lines 12 and/or the second conductive lines 14 and/or at the nodes 16.

In the illustrated example, the plurality of first conductive lines 12 are rectilinear and parallel to the first direction D1 and the plurality of second conductive lines are rectilinear and parallel to the second direction D2. However, in other embodiments the conductive lines may not be straight, they may, for example, be sinuous or zig-zag.

The conductive lines 12, 14 are thin having a width that is less than 10 μm. The width may, in some but not necessarily all examples, be between 5 and 10 μm.

In the illustrated example, first conductive lines 12 are arranged with a regular separation. Each first conductive line 12 is separated from an adjacent first conductive line 12 by a constant distance greater than, for example, twenty times a constant width of the lines. The distance between the lines may, for example, be between lines 200-300 μm and the width may be between 5 and 10 μm.

In the illustrated example, the second conductive lines 14 are arranged with a regular separation. Each second conductive line 14 is separated from an adjacent second conductive line 14 by a constant distance greater than twenty times a constant width of the lines. The distance between the lines may, for example, be between lines 200-300 μm and the width may be between 5 and 10 μm.

In some examples, between 2% and 10% of the area is covered by conductive lines and the rest of the area, between 90% and 98%, is free-space.

FIGS. 2 & 3 schematically illustrate a circular polarizer 4. The circular polarizer 4 comprises, in combination, a ¼ wave retarder 6A and a linear polarizer 6B. The conductive interconnect 10 has been applied directly to an exterior surface 3 of the circular polarizer 4.

FIG. 2 schematically illustrates a circular polarizer 4 where the conductive interconnect 10 has been applied directly to an exterior surface 3A of the ¼ wave retarder 6A.

The linear polarizer 6B is integrated at a first surface of the ¼ wave retarder 6A and the conductive interconnect 10 is integrated at a second opposing surface 3A of the ¼ wave retarder 6A.

FIG. 3 schematically illustrates a circular polarizer where the conductive interconnect 10 has been applied directly to an exterior surface 3B of the linear polarizer 6B.

The ¼ wave retarder 6A is integrated at a first surface of a linear polarizer 6B and the conductive interconnect 10 is integrated at a second opposing surface 3A of the linear polarizer 6B.

FIG. 4 schematically illustrates a device 30. The device 30 comprises a display module 32 and a transparent touch window module 20.

The display module 32, in this example, comprises a display 24 and an overlying circular polarizer 4′. This circular polarizer does not have an integrated conductive interconnect 10. In other examples, there may only be an emissive display, such as an organic light emitting diode (OLED) display, without an overlying circular polarizer.

The touch window module 20 comprises the circular polarizer 4 and an overlying integrated window 22. As described above, the polarizer 4 comprises the apparatus 2 illustrated in FIG. 1. That is, the circular polarizer 4 of the touch window module 20 comprises conductive interconnect 10 integrated with the lower surface of the ¼ wave retarder 6A of the circular polarizer 4. The conductive interconnect 10 is positioned and configured to face the display 24 in use.

An air gap 26 separates the display module 32 and the touch window module 20.

The conductive interconnect 10 provides one or more electrodes for touch detection. For example, the conductive interconnect may provide an array of capacitors for touch detection.

Light passing from in-front of the window 22 into the device 30 will be circularly polarized in a first sense by the circular polarizer 4 of the touch window module 30. If that circularly polarized light is internally reflected of the conductive interconnect 10, for example, the sense of circular polarization is reversed. The reflected light is therefore absorbed by the circular polarizer 4 of the touch window module 30 as it attempts to exit the device 20. This means that the conductive interconnect 10 is not illuminated and made visible by an external light source.

There may therefore be advantages to positioning the conductive interconnect 10 on the exterior surface 3A of the ¼ wave retarder 6A facing the display 24, as illustrated.

However, the conductive interconnect 10 may, alternatively be positioned at the interface between the ¼ wave retarder 6A and the linear polarizer 6B, or on the exterior surface 3B of the linear polarizer 6B.

The method of manufacturing the apparatus 2 may comprise providing a component 6 of a circular polarizer 4 having an exterior surface; and providing a conductive interconnect 10 on an exterior surface of the component 6 of the circular polarizer 4.

An additive process may be used to provide the conductive interconnect 10 directly onto the exterior surface of the component 6 of the circular polarizer 4.

Alternatively a subtractive process may be used to provide the conductive interconnect 10 directly onto the exterior surface of the component 6 of the circular polarizer 4.

In the preceding examples, the apparatus 2 comprised a single conductive interconnect 10, which may for example be a metal mesh. In other examples, the apparatus 2 may comprise multiple metal interconnects. The multiple metal interconnects may, in some examples, be separate metal meshes.

FIG. 5 schematically illustrates a portion or a whole of either a circular polarizer 4 or a component 6 of a circular polarizer. A first conductive interconnect 10 is integrated with the circular polarizer 4/component 6 and a second conductive interconnect 10′ is integrated with the circular polarizer 4/component 6. A medium 40 separates the first conductive interconnect 10 and the second conductive interconnect 10′. The first conductive interconnect 10 and the second conductive interconnect 10′ may, for example, be separated, parallel metal meshes. The medium 40 may be a transparent dielectric material.

The first conductive interconnect 10 and the second conductive interconnect 10′ may, for example, be on the same side of a component 6. The medium 40 may be an added transparent isolation layer.

Alternatively, the first conductive interconnect 10 and the second conductive interconnect 10′ may, for example, be on opposite sides of the component 6. A transparent body of the component 6 provides the medium 40.

Alternatively, the first conductive interconnect 10 and the second conductive interconnect 10′ may, for example, be on the same side of the circular polarizer 4 and the medium 40 may be an added transparent isolation layer.

Alternatively, the first conductive interconnect 10 and the second conductive interconnect 10′ may, for example, be on opposite sides of the circular polarizer 4. A transparent body of the circular polarizer 4 provides the medium.

As used here ‘module’ refers to a unit or apparatus that excludes certain parts/components that would be added by an end manufacturer or a user.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
a component of a circular polarizer; and
conductive interconnect integrated with the component of the circular polarizer.

2. An apparatus as claimed in claim 1, wherein the conductive interconnect is applied directly to an exterior surface of the circular polarizer.

3. An apparatus as claimed in claim 2, wherein the circular polarizer comprises a ¼ wave retarder and a linear polarizer, the linear polarizer is integrated at a first surface of the ¼ wave retarder and the conductive interconnect is integrated at a second opposing surface of the ¼ wave retarder.

4. An apparatus as claimed in claim 1, wherein the conductive interconnect is applied directly to an exterior surface of a ¼ wave retarder.

5. An apparatus as claimed in claim 1, wherein the conductive interconnect is applied directly to an exterior surface of a linear polarizer.

6. An apparatus as claimed in claim 1, wherein the conductive interconnect is applied directly to the component of the circular polarizer without an intervening substrate.

7. An apparatus as claimed in claim 1, wherein the component of the circular polarizer without an intervening substrate comprises a polyethylene terephthalate component to which the conductive interconnect is directly applied.

8. An apparatus as claimed in claim 1, wherein the conductive interconnect is ductile.

9. An apparatus as claimed in claim 1, wherein the conductive interconnect comprises metal.

10. An apparatus as claimed in claim 1, wherein the conductive interconnect comprises a plurality of first conductive lines extending in a first direction and a plurality of second conductive lines extending in a second direction, orthogonal to the first direction, wherein a least some of the plurality of first conductive lines and the plurality of second conductive lines interconnect.

11. An apparatus as claimed in claim 10, wherein the plurality of first conductive lines are parallel to the first direction and the plurality of second conductive lines are parallel to the second direction.

12. An apparatus as claimed in claim 1, wherein the conductive interconnect is a mesh.

13. An apparatus as claimed in claim 12, wherein the mesh occupies a single plane.

14. An apparatus as claimed in claim 1, wherein the conductive interconnect comprises a plurality of thin conductive lines having a width that is less than 10 μm.

15. An apparatus as claimed in claim 1, wherein the conductive interconnect comprises a plurality of thin conductive lines separated by a distance of greater than twenty times a width of the lines.

16. An apparatus as claimed in claim 1, further comprising an additional conductive interconnect.

17. An apparatus as claimed in claim 1, further comprising an additional conductive interconnect integrated with the component of the circular polarizer.

18. An apparatus as claimed in claim 17, wherein the conductive interconnect is a first mesh and the additional conductive interconnect is a second mesh overlying the first mesh and separated from the first mesh by an isolation layer.

19. An apparatus as claimed in claim 18, wherein the first mesh, the isolation layer and the second mesh are integrated on a same side of the component of the circular polarizer.

20. A touch window module comprising the apparatus as claimed in claim 1.

21. A touch window module as claimed in claim 20, wherein the conductive interconnect is positioned and configured to face a display in use.

22. A touch window module as claimed in claim 20, wherein the conductive interconnect provides one or more electrodes for touch detection.

23. A touch window module as claimed in claim 20, wherein the conductive interconnect provides an array of capacitors for touch detection.

24. A method comprising:
providing a component of a circular polarizer having an exterior surface; and
providing a conductive interconnect on an exterior surface of the component of the circular polarizer.

25. A method as claimed in claim 24, wherein providing the conductive interconnect comprises providing the conductive interconnect, using an additive process, directly onto the exterior surface of the component of the circular polarizer.

26. A method as claimed in claim 24, wherein providing the conductive interconnect comprises providing the conductive interconnect, using a subtractive process, directly onto the exterior surface of the component of the circular polarizer.
